(19) United States
(12) Patent Application Publication
(10) Pub. No.: US 2005/0205284 A1
(43) Pub. Date: Sep. 22, 2005

(54) Cover plate for wall mounted device

(76) Inventor: Brian M. Ray, Dallas, TX (US)

Correspondence Address: GRADY K. BERGEN, 3333 LEE PARKWAY, SUITE 600, DALLAS, TX, 75219, US

(21) Appl. No.: 10/804,697

(22) Filed: Mar. 19, 2004

(51) Int. Cl. H02G 3/14

(52) U.S. Cl. 174/66

(57) ABSTRACT

A cover plate for a switch, receptacle or outlet device of a wall is provided with a first plate member having a forward surface. A second plate member is coupled to the first plate member and overlays the forward surface of the first plate member. The second plate member has a different configuration from that of the first plate member so that at least a portion of the forward surface of the first plate member is exposed. The second plate member is visibly distinct from the first plate member. At least one of the first and second plate members has an opening to facilitate access of the device of the wall when the cover plate is mounted thereto.

### BACKGROUND

This invention relates to cover plates for wall mounted devices.

### BRIEF DESCRIPTION OF THE DRAWINGS

For a more complete understanding of the present invention, and the advantages thereof, reference is now made to the following descriptions taken in conjunction with the accompanying figures, in which:

FIG. 1 is a front elevational view of a single-toggle cover plate constructed in accordance with the invention;

FIG. 2 is a front axonometric view of the cover plate of FIG. 1;

FIG. 3 is a front exploded axonometric view of the cover plate of FIG. 1;

FIG. 4 is a front elevational view of a double rocker cover plate constructed in accordance with the invention;

FIG. 4A is a front elevational view of a forward plate member of the cover plate of FIG. 4;

FIG. 4B is a front elevational view of rear plate member of the cover plate of FIG. 4;

FIG. 4C is a front elevation view of a mounting plate member of the cover plate of FIG. 4;

FIG. 5 is a front elevational view of an electrical outlet cover plate constructed in accordance with the invention;

FIG. 5A is a front elevational of a forward plate member of the cover plate of FIG. 5;

FIG. 5B is a front elevational of rear plate member of the cover plate of FIG. 5; and

FIG. 5C is a front elevation view of a mounting plate member of the cover plate of FIG. 5.

### DETAILED DESCRIPTION

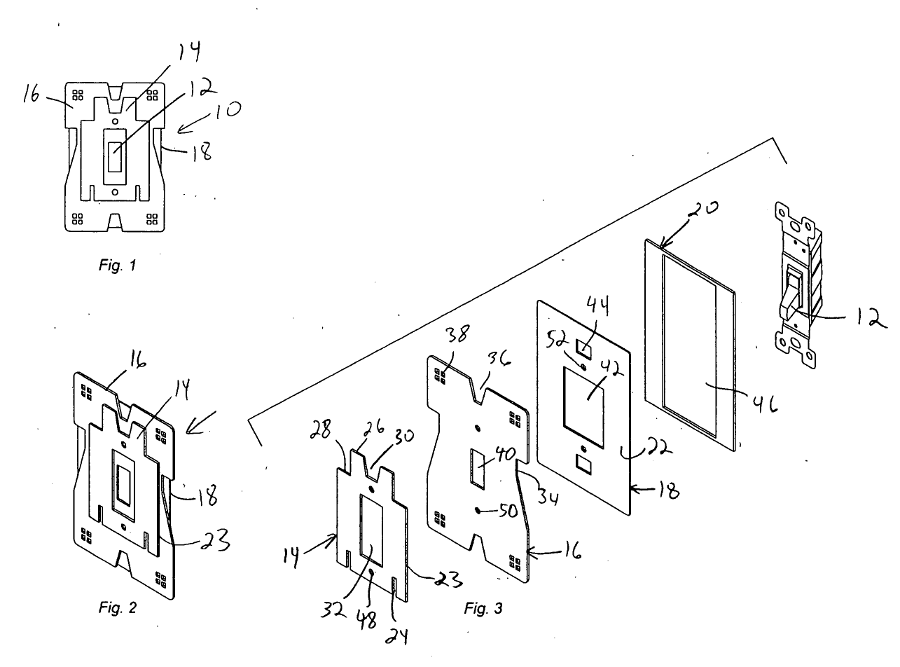

A decorative cover plate 10 is shown in FIGS. 1 and 2 for an exposed switch, receptacle, outlet, or other device (not shown) mounted to or in a wall. Such devices may include, but are not limited to, toggle or rocker-type switches; dimmer or dial switches or controls; electrical power outlets or receptacles; phone, data or cable jacks, receptacles or connections; etc. Such devices may be mounted into a wall of a dwelling structure by means of an outlet or fixture box that may be recessed within the wall itself. Such boxes may be used to house the wiring, connections or other components of the wall-mounted devices. Alternatively, the device may pass through the wall and be connected directly to the cover plate without any such housing or box.

The cover plate facilitates a finished appearance to the wall to which it is mounted, covering unsightly holes or gaps formed or provided in the wall to facilitate installation of the wall mounted device. The cover plate also hides wiring or other components of the device, and prevents accidental or inadvertent contact or access to such wiring or components, which are usually meant to remain inaccessible and hidden.

For purposes of illustrating the invention, a cover plate 10 constructed in accordance with the invention is shown. In this instance, the cover plate 10 is configured for use with a single toggle switch 12 (FIG. 3), such as those used in turning light fixtures off and on, and which may be mounted to a wall of a building or other structure. The plate 10 includes individual decorative plate members 14, 16 and 18. A bottom, non-exposed mounting plate member 20 is provided to facilitate mounting of the plate 10 flush to the wall. As used herein, expressions such as “bottom,” “lower, “upper,” “forward,” “rear,” “overlaying,” “over,” “under,” “underlying,” etc. are used for ease of description to reflect relative orientation and should not necessarily be construed in any limiting sense. Each of the plate members 14, 16, 18 may be a generally planar member that has a forward surface 22. At least a portion of the forward surfaces 22 of each of the plate member 14, 16, 18 of the cover plate remains exposed.

Each of the plate members 14, 16 and 18 of the cover plate has a configuration that is different from the others. This difference in configuration may be provided by a variety of different means, but includes differences in size and shape of the plate members. Differences in shape may be provided by open areas of the plate members. As used herein, the expression “open area(s)” is meant to include both cut out areas and apertures formed through the thickness of the plate members. As used herein, “cut out area(s)” is meant to include those open areas, such as a slot, recess, groove, shoulder, etc., whether or not they are actually formed by the act of cutting, made along the perimeter or along the side edges of the plate members, with one or more sides being open. As used herein, “aperture(s)” are meant to include holes or openings formed within an interior of the plate member so that the all sides of the hole or opening is bounded by portions of the plate member. Such open areas may have curved, both constant and variable radius curves, or angular sides or edges.

Differences in the configuration of the plate members may also be provided by differences in the relative positions or orientations of the plate members. Thus, the plate members may have an identical or similar shape, but are placed in a non-superimposed relationship, wherein portions of the underlying plate member(s) remain exposed when viewed from an angle generally perpendicular to the plane of the plate members or the wall or surface to which the cover plate is mounted.

The plate members may be formed from a variety of different materials. These may include various metal materials, which include, but are not limited to, iron, copper, steel, stainless steel, galvanized steel, mild or carbon steel, aluminum, anodized aluminum, bronze, nickel, tin, iron, brass, and alloys of such materials and other metals. Other non-metal materials may also be used, such as wood. Examples of various decorative suitable wood materials include, but are not limited to, makasar ebony, birdseye, sycamore, makore, beech, mahogany, sapele, bosse, kiwazinga, lacewood, rosewood pau ferro, Zebrawood, red oak, white oak, cherry, etimoe, walnut, maple, wenge, anigre, bubinga and purple heart. The wood materials may be solid pieces, but may also be laminates. Laminates may be formed of several laminate layers, for example from 2 to 6 laminates. Other non-metal or non-wood materials may also be used. These may include, but are not limited to, plastics or polymeric materials, leather, textile materials, composite materials, clays, ceramics, glass (including mirrored glass), etc. The materials used may be treated or coated to prevent or retard combustion, if necessary. The materials may be opaque, translucent or transparent.

The decorative plate members 14, 16, 18 may each be provided with a finish or surface treatment on at least the forward surface or exposed areas to provide a decorative appearance. This may include finishes or surface treatments that provide a desired texture, color or both. The finish may be matte or non-matte and be provided by various means. A mirror finish may also be provided. A combination of more than one finish or surface treatment may also be provided to each plate member. The surface of the plate members may also be provided with etched areas, impressions or recessed areas that do penetrate the entire thickness of the plate member. Etching may be achieved through laser etching. For wood materials, this may provide a burned area along the edges of the etching that may be aesthetically desirable. Additionally, ridges or raised areas of various patterns or configurations may also be provided on portions of the decorative plate members.

Examples of surface treatments for various metals include polished or brushed finishes; polished or brushed steel; rusted finishes for mild or carbon steel or iron; polished, brush, patina or heat stained finishes for copper; anodized aluminum; polished, brushed or heat stained finish for brass; and polished, brushed or heat stained finish for bronze. For wood materials, surface treatments may include natural, sealed glossy or stained and sealed. Wood materials may be sealed or unsealed. In certain embodiments, the plate members may contrast in appearance with one another. This may be provided, in part, by the finish or surface treatment or differences in the types of materials used (e.g. a combination of steel and copper).

Additionally, the plate members 14, 16, 18 may have a thickness sufficient to provide a visually perceptible three-dimensional contrast or layered appearance. The thickness of each plate may be from about 1/32 of an inch or more, with from about 1/16 of an inch to about 3/32 or ⅛ of an inch being more typical. This provides a readily perceptible side edge 23 (FIGS. 2 and 3) along the periphery of the plate members when viewed at a non-perpendicular angle to the plane of the plate members that facilitates a three-dimensional appearance. This side edge 23 may be perceived by one with normal 20/20 vision in generally well lighted conditions at a distance of from at least 5 feet, 6 feet, 7 feet, 8 feet, 9 feet, 10 feet, or even 15 feet or more, when viewed at a non-perpendicular angle to the plane of the plate members.

Together, the plate members may provide the cover plate with a substantial or “weighty” appearance. With respect to those cover plates constructed from solid metal plate members, the cover plate may have a weight of from about 4, 5, 6, 7 or 8 to about 16 ounces or more. The thickness of the plate members, however, may be selected so that the total thickness of the plate members does not interfere or impede the operation of the device for which the cover plate is being used. The plate members may appear visibly distinct from one another so that each plate member generally appears as individually separate plate member. Additionally, a unitary construction may be provided wherein the several plate members are formed from a single, solid piece of material, wherein the material has been machined, molded or otherwise formed to provide raised areas that provide the appearance of independent plate members. In such unitary construction, relatively sharp, angular edges or corners may be provided along the side edges of the raised areas that define the plate members where they project from the underlying surface to provide them with a visibly distinct appearance.

The members may be cut to shape or otherwise formed to shape by various means. Cutting methods may include laser or water-jet cutting or other mechanical cutting methods, such as sawing, CNC machining, stamping, drilling, etc. The plate members may also be formed by non-cutting methods, such as by casting or molding. Laser cutting may be used for woods and may provide burnt edges adjacent to the cut. These burnt edges may be left to provide a desired appearance, but can also be removed by sanding or filing or other means. Rough or sharp edges may be smoothed, if desired, by means of filing, sanding or other methods. Relatively sharp corners of the plate members may be provided with a minimum radius for safety purposes.

The finishes or surface treatments may also be provided in different ways. For example, for brushed steel or other metals, the surface of the metal plate may be sanded with a various size grit sanding materials (e.g. 60, 80, 100, 120 grit). Linear and arcuate brushed appearances may be provided using different sanding means, such as a belt or orbital sander, respectively. A hand-brushed appearance may also be provided by sanding by hand. For copper or other similar metals, a patina finish may be provided by applying a patina finishing solution to provide a blue, green or other patina finish. An example of such commercially available finishing solutions includes MODERN OPTIONS™ Patina Green and MODERN OPTIONS™ Blue Antiquing Solution. The finishing solution may be applied by means of a sponge or other applicator containing the solution and patting it onto the metal surface. One, two, three or more coats may be applied to provide the desired finish. Heat staining finishes may be achieved by directing a high-temperature flame, such as from a butane or acetylene torch, to the surface of the metal until the metal is oxidized or discolored in various hues.

A rusted finish, such as on mild or carbon steel, may be provided using a rusting solution. The rusting solution may be applied in a similar manner to that described for the patina finish on copper. One or more coats may be applied. A suitable commercially available rusting solution is that available as MODERN OPTIONS™ Instant Rust Antiquing Solution. A sealant may be applied to the rusted metal to prevent rust from rubbing off. Screws or fasteners may also be provided with a rusted metal finish. This may be achieved by using brass finish washers and screws that are treated with a brass darkening solution. Painted screws and washers may also be used. All or a portion of such screws, washers or fasteners may be so treated.

For anodizing, the anodizing may be provided after the plate member has been cut or formed to shape and may be provided after brushing or other surface treatments. Conventional anodizing methods may be used to provide anodized finishes of various colors and shades.

Metals may be provided with a protective coating, such as a “sweet dip,” acrylic seal or a baked clear powder coating to prevent tarnishing from contact from skin oils and moisture.

Referring to embodiment of FIG. 3, the forward plate member 14 of the cover plate 10 has a generally rectangular shape. Two upwardly extending parallel linear slots 24 are formed in the lower end of the member 14. At the upper end of the plate member 14 is a projection 26 that defines opposite shoulder portions 28. The upper end of the projection 26 has a central keystone-shaped slot or recess 30 formed therein. A rectangular opening or aperture 32 is formed generally in the center of the plate member 14 through the entire thickness of the member 14.

The intermediate plate member 16 that immediately underlies plate member 14 has a generally rectangular shape, with an overall length and width that is greater than that of the plate member 14. Cutout areas 34 are formed along the sides of the plate member 16. Centered at each end of the plate member 16 is a keystone-shaped slot 36. Located at each corner of the plate member 16 are four small generally square shaped apertures 38 formed through the entire thickness of the plate member 16. The apertures 38 are arranged in a generally square-shaped arrangement, as shown. A rectangular aperture or opening 40 is provided generally in the center of the plate member 16. The rectangular opening 40 may be proportional in dimensions to the opening 32 of the plate member 14, but is smaller than the opening 32.

The rear plate member 18 that immediately underlies plate member 16 has a generally rectangular shape, with an overall length and width that is greater than that of the plate member 14, but that is slightly smaller than the intermediate plate member 16. A central opening or clearance area 42 is provided in the plate member 18, which is generally larger than the opening 40 of plate member 16. Openings or clearance areas 44 are also formed in the plate member 18 at either end, which will be described in more detail below.

The mounting plate member 20 underlies the plate member 18 and is generally rectangular in shape, having a length and width that is slightly smaller than that of the plate member 18. The mounting plate 20 has a thickness that may be less than that of the plate members 14, 16, 18. The mounting plate member 20 is provided with a large central opening 46, which overlays the openings 42 and 44 of the plate member 18. The mounting plate 20 facilitates mounting of the cover plate 10 to the light switch so that it may be mounted flush against the wall surface.

As shown in FIG. 2, each of the plate members 14, 16, 18 and mounting plate member 20 are coupled or joined to one another, with the rear surface of plate members 14, 16 and 18 facing the forward surface of plate members 16, 18 and 20, respectively. The plate members 14, 16, 18 and 20 may be coupled or joined together by various means. This may include the use of glues, adhesives, adhesive tapes or bonding agents, mechanical fasteners, such as screws, pins, stitching, wire, bolts or rivets, etc.; welding or soldering; etc. An example of suitable bonding means include the use of thin, double-sided very high bond (VHB) adhesive tapes, such as high bonding acrylic tapes. Such tapes may have a thickness of 1 mm or less. An example of a suitable commercially available very high bonding tape is that available as SCOTCH 3M VHB Tape having a thickness of 0.25 mm. For metal plate members, a metal epoxy or other bonding agent may be used.

Each of the plate members 14, 16, 18 is provided with holes 48, 50, 52, respectively, that are aligned with one another, as shown, when the plate members coupled together. The holes 48, 50, 52 facilitate the mounting of the cover plate 10 to the wall by allowing a passage of screw or fastener that threads or secures to the holes (not shown) of wall box or other device mounted to the wall to which the cover plate 10 is to be mounted. The holes 50, 52 of the underlying plate members may be larger than the hole 48 of plate member 14 for clearance or alignment purposes. The fasteners used may be of different materials and be provided with desired finishes or surface treatments. With respect to the hole 48 of the forwardmost plate member 14, the hole 48 may be countersunk or beveled along the edges to facilitate flush seating of the fastener head. Optionally, finish washers (not shown) may be used with the screws, bolts or other fasteners. These also may be provided with various finishes or treatments to compliment the cover plate.

When the cover plate 10 is mounted to the wall, the toggle switch 12 is accommodated by the openings 32, 40, 42 and 46, so that the toggle switch 12 or device may project through the cover plate 10 or otherwise be accessible

As seen in FIG. 1, a portion of each of the plate members 14, 16, 18 is visible when the plate members 14, 16, 18 are assembled together to form the cover plate 10. Thus, portions of forward surface of the rearwardmost plate member 18 are visible through cutout areas 34 and 36 and apertures 38 of the overlying plate member 16. Likewise, portions of the forward surface of the plate member 16 are visible through open areas 24, 28, 30, 32 and 38 of the plate member 14, as well as due to the smaller dimensions of the plate member 14.

Where each of the next adjacent plate members 14, 16 and 18 are of different materials or provided with different finish or surface treatment, the contrast between the plate members 14, 16, is accentuated. This facilitates a unique and decorative appearance.

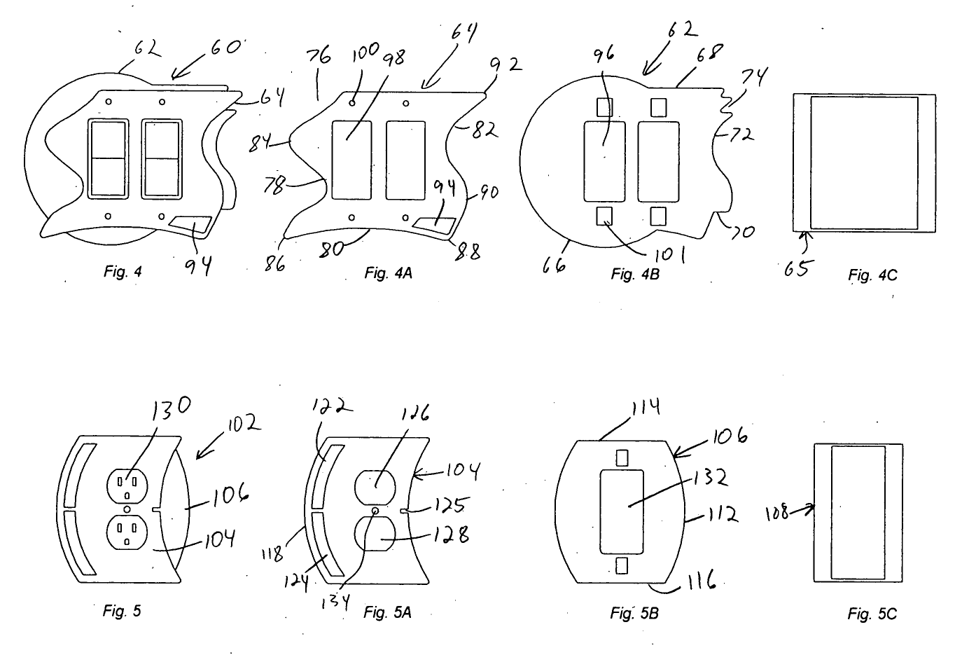

Referring to FIG. 4, another embodiment is shown of a cover plate 60 for use with a double rocker-type light switch. The cover plate 60 is similar to the cover plate 10, but employs only two exterior decorative plate members 62, 64 of differing configuration that are joined together. The cover plate 60 may include a mounting plate member 65 (FIG. 4C) having a large central opening similar to the member 20 of cover plate 10. The rear plate member 62 (FIG. 4B) includes a main circular shaped portion 66. Extending generally transversely from the circular portion 66 is a non-circular projecting portion 68, which has various cutout areas 70, 72, 74 of various shapes, which may be of constant or variable radius arcuate shapes, along the side of the projecting portion 68.

Overlaying the plate member 62 is plate member 64 (FIG. 4A). The plate member 64 has a wave-like configuration and is provided with concave arcuate cutout areas 76, 78, 80, 82 and convex arcuate projections 84, 86, 88, 90, 92, which may be of constant or variable radius arcuate shape, to provide a generally side-to-side undulating pattern. An aperture 94 is also formed through the thickness of the plate member 64 in the projecting portion 88.

A pair of light switch apertures 96, 98 is formed in each of the plate members 62, 64, respectively, to facilitate passage or access to the light switch for which the cover plate 60 is being used. The apertures 96, 98 may be configured to closely receive the rocker switches. Additionally, holes 100 formed in plate member 64, with corresponding clearance apertures 101 formed in plate member 62, for screws or other fasteners to facilitate mounting of the cover plate to a wall or wall box are also provided.

As can be seen in FIG. 4, the plate members 62, 64 are each configured so that portions of the forward surface of each member 62, 64 are visible when viewed at an angle generally perpendicular to the plate members or the wall or surface to which the cover plate 60 is mounted. Portions of both the underlying plate member 62, as well as portions of the wall or surface to which the cover plate 60 is mounted, are visible through aperture 94 of plate member 64. The surfaces of plate members 62, 64 may also be provided with different finishes or surface treatments or may be of different materials to provide a contrast with one another.

Referring to FIG. 5, another cover plate 102 is shown. The cover plate 102 is configured similarly to the cover plates 10 and 60, but is configured for use with an electrical outlet of a wall. The cover plate 102 also includes forward and rear plate members 104, 106, each having different configurations so that portions of each to be visible when viewed at an angle generally perpendicular to the plane of the cover plate 102 or wall or other surface to which the cover plate 102 is mounted. The cover plate 102 may also include a mounting plate member 108 (FIG. 5C) having a large central opening.

The bottom plate member 106 (FIG. 5B) is generally symmetrical along a longitudinal line bisecting the member 106. The plate member 106 has projecting constant-radius convex arcuate sides 110, 112, with the upper and lower ends 114, 116 being flat and parallel to one another so that the member 106 appears generally as an oval with flat truncated ends.

Overlaying the plate member 106 is forward plate member 104 (FIG. 5A). The plate member 104 has a projecting convex arcuate side edge 118 of a generally constant radius that is substantially equal to the radius of side edge 110 of plate member 106. The opposite side edge 120 has a cut-out concave arcuate configuration of constant radius that follows a line generally parallel to the arcuate side edge 110. The upper and lower ends of the plate member 104 are generally flat and parallel to each other. A pair of elongate upper and lower arcuate apertures 122, 124 are formed adjacent to side edge 118 and are generally aligned parallel to the side edge 118. A horizontal slot 125 is provided in the side edge 120. The slot 125 is aligned with and generally equal in width and length to the space provided between the apertures 122, 124. Upper and lower openings 126, 128 are provided in plate member 104, which may closely receive and facilitate access to outlet sockets 130 (FIG. 5). A central elongate opening 132 is also provided in plate member 106 to facilitate sockets 130, as well. A hole or clearance area 134 may also be provided in plate member 134 for receiving a fastener to facilitate mounting of the cover plate 102 to the wall or outlet. The edges of the hole 134 may also be beveled or countersunk so that the head of the fastener may be received therein to provide a flush appearance and which may eliminate the need for a finish washer.

As can be seen in FIG. 5, the plate members 104, 106 are each configured so that portions of the forward surface of each member 62, 64 are visible when viewed at an angle generally perpendicular to the plate members 104, 106 or the wall or surface to which the cover plate 102 is mounted. Portions of the underlying plate member 106 are visible through the elongate apertures 122, 124, as well as the cut-out area 120 and 125. The plate members 104, 106 may be of different materials or the surfaces of the plate members 104, 106 may be provided with different finishes or surface treatments to provide a contrast with one another.

While the invention has been shown in only some of its forms, it should be apparent to those skilled in the art that it is not so limited, but is susceptible to various changes and modifications without departing from the scope of the invention. Accordingly, it is appropriate that the appended claims be construed broadly and in a manner consistent with the scope of the invention.

1. A cover plate for a switch, receptacle or outlet device of a wall comprising:
a first plate member having a forward surface;
a second decorative plate member having a thickness of from 1/32 of an inch or more coupled to the first plate member and overlaying the forward surface of the first plate member, the second plate member having a different configuration from that of the first plate member so that at least a portion of the forward surface of the first plate member is exposed, the forward surface of the second plate member having no substantial surface-projecting element extending therefrom, the second plate being visually distinct from the first plate member; and wherein
at least one of the first and second plate members has an opening to facilitate access of the device of the wall when the cover plate is mounted thereto.

2. The cover plate of claim 1, wherein:
the first and second plate members each have a forward surface that is different from the other to provide a visually perceptible contrast between the first and second plate members.

3. The cover plate of claim 1, wherein:
the first and second plate members each have a forward surface that is provided with a different surface finish from the other to provide a visual perceptible contrast between the first and second plate members.

4. The cover plate of claim 1, wherein:
the second plate member has a thickness of from 1/16 of an inch or more.

5. The cover plate of claim 1, wherein:
the different configuration of the second plate member is provided at least one of a cutout or aperture formed through the thickness of the second plate member.

6. The cover plate of claim 1, wherein:
the plate members are formed of a metal or metal alloy.

7. (canceled)

8. The cover plate of claim 1, wherein:
the first and second plate members are formed from at least one of copper, steel, carbon steel, aluminum, bronze, nickel, tin, iron, brass, and alloys of such materials, wood, polymeric materials, leather, fabric, composite materials, clays, ceramics and glass.

9. The cover plate of claim 1, wherein:
each of the first and second plate members is opaque.

10. The cover plate of claim 1, wherein:
one of the plate members has a matte forward surface and the other plate member has a non-matte forward surface.

11. The cover plate of claim 1, wherein:
the first and second plate members each have sufficient thickness to provide a visually perceptible layered appearance.

12. The cover plate of claim 1, wherein:
the first and second plate members are coupled together with a very high bond adhesive tape.

13. A cover plate for a switch, receptacle or outlet device of a wall comprising:
a first plate member having a forward surface;
a second decorative plate member having a thickness of from 1/32 of an inch or more coupled to the first plate member and overlaying the forward surface of the first plate member, the second plate member having a different configuration from that of the first plate member so that at least a portion of the forward surface of the first plate member is exposed, the forward surface of the second plate member having no substantial surface-projecting element extending therefrom, the second plate member having a sufficient thickness to provide a readily perceptible side edge and being visually distinct from the first plate member; and wherein
at least one of the first and second plate members has an opening to facilitate access of the switch or receptacle of the wall when the cover plate is mounted thereto.

14. The cover plate of claim 13, wherein:
the first and second plate members each have a forward surface that is different from the other to provide a visually perceptible contrast between the first and second plate members.

15. The cover plate of claim 13, wherein:
the first and second plate members each have a forward surface that is provided with a different surface finish from the other to provide a visual perceptible contrast between the first and second plate members.

16. The cover plate of claim 13, wherein:
the second plate member has a thickness of from 1/16 of an inch or more.

17. The cover plate of claim 13, wherein:
the different configuration of the second plate member is provided by at least one of a cutout or aperture formed through the thickness of the second plate member.

18. The cover plate of claim 13, further comprising:
a third plate member that overlays the first and second plate members, the third plate member having a configuration that is different from that of the first and second plate members so that at least a portion of the forward surface of each of the first and second plate members is exposed, tie third plate member having a sufficient thickness to provide a visually perceptible layered appearance.

19. The cover plate of claim 13, wherein:
one of the plate members has a matte forward surface and the other plate member has a non-matte forward surface.

20. A cover plate for a switch, receptacle or outlet device of a wall comprising:
a first plate member having a forward surface;
a second decorative plate member coupled to the first plate member and overlaying the forward surface of the first plate member, the second plate member having a different configuration from that of the first plate member so that at least a portion of the forward surface of the first plate member is exposed, the first and second plate members each have a forward surface that is provided with a different surface finish from the other to provide a visual perceptible surface contrast between the first and second plate members, the forward surface of the second plate member having no substantial surface-projecting element extending therefrom, and the second plate member having a thickness of from 1/32 of an inch or more to provide a readily perceptible side edge and being visually distinct from the first plate member; and wherein
at least one of the first and second plate members has an opening to facilitate access of the switch or receptacle of the wall when the cover plate is mounted thereto.

21. A cover plate for a switch, receptacle or outlet device of a wall comprising:
a first plate member having a forward surface;
a second plate member having a thickness of from 1/32 of an inch or more coupled to the first plate member and overlaying the forward surface of the first plate member, the second plate member having a different configuration from that of the first plate member so that at least a portion of the forward surface of the first plate member is exposed, the forward surface of the second plate member having no substantial surface-projecting element, the second plate being visually distinct from the first plate member; and wherein
at least one of the first and second plate members has an opening to facilitate access of the device of the wall when the cover plate is mounted thereto; and
a third plate member that overlays and is coupled to the first and second plate members, the third plate member having a configuration that is different from that of the first and second plate members so that at least a portion of the forward surface of each of die first and second plate members is exposed, the third plate member being visibly distinct from the first and second plate members.
